(19) United States
(12) Patent Application Publication
(10) Pub. No.: US 2026/0152014 A1
(43) Pub. Date: Jun. 4, 2026

(54) RECORDING APPARATUS

(71) Applicant: SEIKO EPSON CORPORATION, Tokyo (JP)

(72) Inventors: Yayoi YOSHIMURA, MATSUMOTO-SHI (JP); Masashi OGAWA, SHIOJIRI-SHI (JP)

(21) Appl. No.: 19/405,756

(22) Filed: Dec. 2, 2025

(30) Foreign Application Priority Data
Dec. 4, 2024 (JP) 2024-211004

(51) Int. Cl. B41J 13/10; B41J 2/175; B41J 13/03; B41J 29/13

(52) U.S. Cl. CPC B41J 13/103; B41J 2/17566; B41J 13/03; B41J 29/13; B41J 2002/17573

(57) ABSTRACT

A recording apparatus includes a cassette configured to house a medium, a main body portion in which the cassette is attached, and a recording unit configured to record an image on the medium, wherein the cassette includes a container configured to house the media, and a hopper plate attached to the container, the main body portion includes a housing in which the cassette is attached, and a lever that is housed in the housing and is configured to move in conjunction with the hopper plate, the lever includes a contact portion configured to come into contact with the hopper plate, and an exposed portion configured to be displaced as the contact portion is displaced, and an exposure opening configured to expose the exposed portion opens on the housing.

The present application is based on, and claims priority from JP Application Serial Number 2024-211004, filed Dec. 4, 2024, the disclosure of which is hereby incorporated by reference herein in its entirety.

### BACKGROUND

### 1. Technical Field

The present disclosure relates to a recording apparatus.

### 2. Related Art

JP-A-7-112844 describes a recording apparatus including a cassette that houses media and a sensor that detects the presence or absence of the media housed in the cassette. The user figures out the presence or absence of the media housed in the cassette based on the detection result of the sensor.

JP-A-7-112844 is an example of the related art.

In such a recording apparatus, it is possible to detect the presence or absence of the media housed in the cassette, while it is difficult to detect the remaining amount of the media housed in the cassette. Therefore, it is difficult for the user to figure out the remaining amount of the media housed in the cassette.

### SUMMARY

A recording apparatus configured to solve the problems described above includes a cassette configured to house a medium, a main body portion in which the cassette is installed, and a recording unit configured to record an image on the medium, wherein the cassette includes a container configured to house the media, and a hopper plate attached to the container, the main body portion includes a housing in which the cassette is attached, and a lever that is housed in the housing and is configured to move in conjunction with the hopper plate, the lever includes a contact portion configured to come into contact with the hopper plate, and an exposed portion configured to be displaced as the contact portion is displaced, and an exposure opening configured to expose the exposed portion opens on the housing.

### BRIEF DESCRIPTION OF THE DRAWINGS

FIG. 1 is a diagram of an inside of a recording apparatus viewed from a lateral side.

FIG. 2 is a diagram of the recording apparatus viewed from the front.

FIG. 3 is a diagram of the inside of the recording apparatus viewed from an upper side.

FIG. 4 is a diagram showing a position of a lever when a remaining amount of media is large.

FIG. 5 is a diagram showing the position of the lever when the remaining amount of the media is smaller than in a state shown in FIG. 4.

FIG. 6 is a diagram showing the position of the lever when the remaining amount of the media is further smaller than in a state shown in FIG. 5.

FIG. 7 is a diagram showing a position of a hopper plate when a cassette is inserted into a housing.

FIG. 8 is a diagram showing the position of the hopper plate when the cassette is further pushed into the housing in the state shown in FIG. 7.

FIG. 9 is a diagram showing the position of the hopper plate when the cassette is further pushed into the housing in the state shown in FIG. 8.

### DESCRIPTION OF EMBODIMENTS

An embodiment of a recording apparatus will hereinafter be described with reference to the drawings. The recording apparatus is an inkjet printer that records characters and an image such as a photograph by ejecting ink, which is an example of a liquid, onto a medium such as paper, fabric, or a film.

### Recording Apparatus

As illustrated in FIG. 1, the recording apparatus 11 includes a cassette 12 and a main body portion 13. The cassette 12 is configured to house a medium 99. The cassette 12 is configured to house the media 99 on which recording has not been performed yet. The main body portion 13 is configured such that the cassette 12 is attached therein. The cassette 12 is detachably attached to the main body portion 13. The cassette 12 is inserted into the main body portion 13 to thereby be attached to the main body portion 13. The cassette 12 is removed from the main body portion 13 by being pulled out from the main body portion 13. The cassette 12 and the main body portion 13 will further be described later.

The recording apparatus 11 includes a recording unit 14. The recording unit 14 is configured to record an image on the medium 99. In one example, the recording unit 14 is configured to record an image on the medium 99 by ejecting a liquid onto the medium 99. The recording unit 14 includes, for example, a head that ejects the liquid. The recording unit 14 may be configured to record an image on the medium 99 with a powder such as toner.

The recording apparatus 11 includes a conveyance unit 15. The conveyance unit 15 is configured to convey the medium 99. The conveyance unit 15 is configured to convey the medium 99 from the cassette 12. The conveyance unit 15 is configured to convey the medium 99 along the conveyance path 16. The conveyance path 16 is a path extending inside the main body portion 13. The conveyance path 16 extends from the cassette 12 toward an outside of the main body portion 13. The conveyance path 16 extends so as to pass through the recording unit 14. The conveyance unit 15 conveys the medium 99 on which recording has not been performed from the cassette 12 toward the recording unit 14. The conveyance unit 15 conveys the medium 99 on which recording has been performed from the recording unit 14 toward the outside of the main body portion 13.

The conveyance unit 15 includes one or more rollers. In one example, the conveyance unit 15 includes two or more rollers. The conveyance unit 15 includes, for example, a supply roller 17. The supply roller 17 is a roller that comes into contact with the medium 99 housed in the cassette 12. The supply roller 17 guides the medium 99 housed in the cassette 12 to the conveyance path 16. The supply roller 17 is a pick roller that takes out the medium 99 from the cassette 12. The supply roller 17 conveys the medium 99 from the rear to the front of the recording apparatus 11. The conveyance unit 15 includes, for example, a plurality of conveyance rollers 18 in addition to the supply roller 17. The plurality of conveyance rollers 18 is located along the conveyance path 16. The plurality of conveyance rollers 18 conveys the medium 99 along the conveyance path 16.

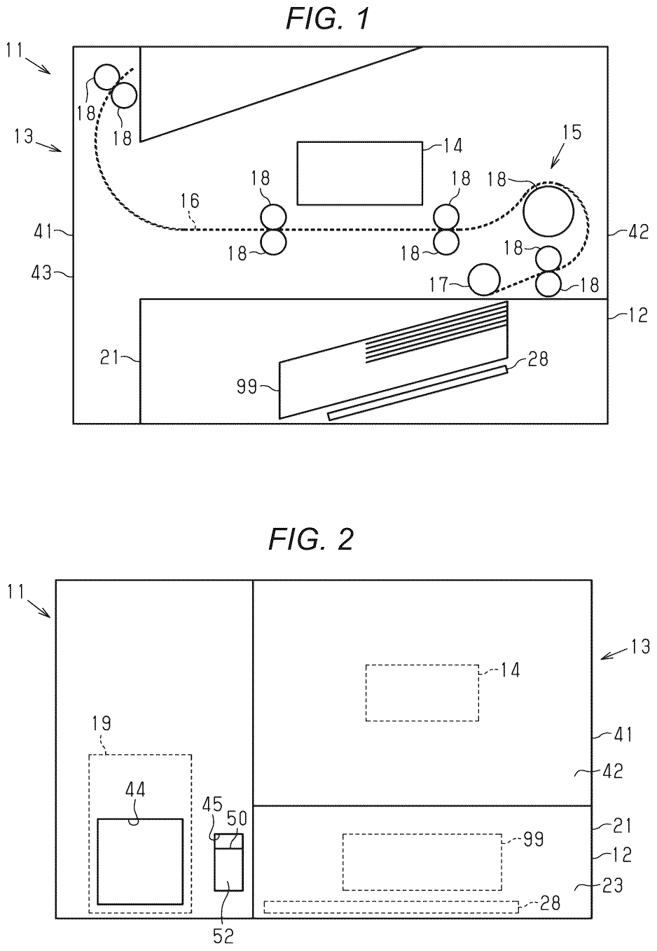

As illustrated in FIG. 2, the recording apparatus 11 may include a liquid container 19. The liquid container 19 is configured to store the liquid. The liquid container 19 stores the liquid to be supplied to the recording unit 14. The liquid container 19 is attached in the main body portion 13. The liquid container 19 is, for example, an ink tank.

### Cassette

Then, the cassette 12 will be described.

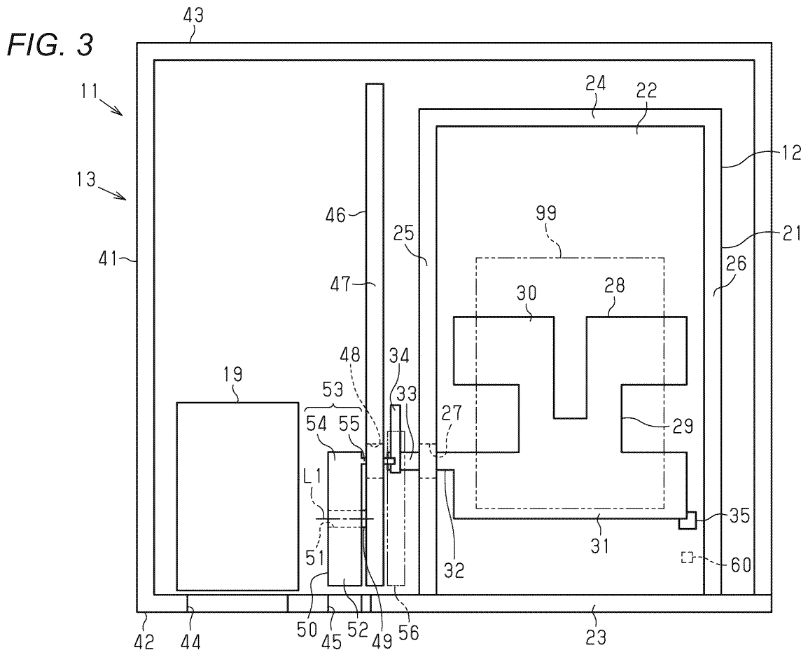

As illustrated in FIGS. 2 and 3, the cassette 12 includes a container 21. The container 21 is a portion that houses the media 99. The container 21 has a rectangular shape or is shaped like a rectangle when viewed from above.

The container 21 has a plurality of walls. The container 21 has a bottom wall 22. The bottom wall 22 is a wall on which the media 99 are stacked. The container 21 includes a front wall 23, a rear wall 24, a passage side wall 25, and an opposed side wall 26. The front wall 23, the rear wall 24, the passage side wall 25, and the opposed side wall 26 are walls each extending from the bottom wall 22. The front wall 23, the rear wall 24, the passage side wall 25, and the opposed side wall 26 are located to surround the media 99.

The front wall 23 is a wall located at the front side in the cassette 12. The front wall 23 is a wall exposed to the outside of the main body portion 13 in the cassette 12 attached in the main body portion 13. The front wall 23 is a wall facing a user who operates the recording apparatus 11. The rear wall 24 is a side wall located at the rear of the cassette 12. The rear wall 24 is opposed to the front wall 23. The passage side wall 25 is a side wall connected to the front wall 23 and the rear wall 24. The passage side wall 25 is a side wall in which a passage opening 27 opens. The passage opening 27 may be a hole or a groove. The opposed side wall 26 is a side wall connected to the front wall 23 and the rear wall 24. The opposed side wall 26 is opposed to the passage side wall 25.

The cassette 12 includes a hopper plate 28. The hopper plate 28 is attached to the container 21. The hopper plate 28 is attached to, for example, the bottom wall 22. The hopper plate 28 may be attached to the passage side wall 25 and the opposed side wall 26.

The hopper plate 28 is configured to move up and down. The hopper plate 28 is configured to move up and down with respect to the bottom wall 22. The hopper plate 28 moves up so as to get away from the bottom wall 22, and moves down so as to approach the bottom wall 22. The hopper plate 28 moves up and down with, for example, elastic force of a spring located between the hopper plate 28 and the container 21. The hopper plate 28 may move up and down with driving force of a motor, an actuator, or the like.

The hopper plate 28 is configured to rotate. The hopper plate 28 moves up and down by rotating. The hopper plate 28 may rotate around one end portion thereof so that the other end portion moves up and down. The hopper plate 28 may be translated in a vertical direction to thereby move up and down instead of rotating.

The hopper plate 28 moves up to thereby lift the media 99. Specifically, the hopper plate 28 lifts the media 99 stacked on the bottom wall 22. The hopper plate 28 presses the media 99 against the supply roller 17 by lifting the media 99. On this occasion, the position of the hopper plate 28 changes in accordance with the remaining amount of media in the cassette 12. The smaller the remaining amount of media in the cassette 12 is, the higher the hopper plate 28 is positioned.

The hopper plate 28 has a main body portion 29. The main body portion 29 is a portion of the hopper plate 28, and the media 99 are stacked on the main body portion 29. The main body portion 29 is located inside the container 21. The main body portion 29 has a base end portion 30 and a tip portion 31. The base end portion 30 is a portion close to the rear wall 24 in the main body portion 29. The tip portion 31 is a portion close to the front wall 23 in the main body portion 29. The main body portion 29 is attached to the container 21 so as to rotate about the base end portion 30. When the main body portion 29 rotates about the base end portion 30, the tip portion 31 moves up and down. By the main body portion 29 rotating about the base end portion 30, the tip portion 31 lifts the media 99.

The hopper plate 28 has a protruding portion 32. In the hopper plate 28, the protruding portion 32 is a portion that protrudes toward the outside of the container 21. The protruding portion 32 extends from the main body portion 29. In one example, the protruding portion 32 extends from the tip portion 31. The protruding portion 32 extends so as to penetrate the passage side wall 25. The protruding portion 32 extends so as to pass through the passage opening 27. The protruding portion 32 extends from the inside of the container 21 to the outside of the container 21 through the passage opening 27.

The protruding portion 32 has a passing portion 33. The passing portion 33 is a portion coupled to the main body portion 29. Specifically, the passing portion 33 is a portion coupled to the tip portion 31. The passing portion 33 is a portion extending so as to pass through the passage opening 27. For example, the passing portion 33 extends perpendicularly to the passage side wall 25.

The protruding portion 32 has an extension portion 34. The extension portion 34 is a portion coupled to the passing portion 33. The extension portion 34 extends from the passing portion 33. The extension portion 34 extends, for example, from the tip of the passing portion 33. The extension portion 34 extends along the passage side wall 25. The extension portion 34 extends along the passage side wall 25 in a direction from the front wall 23 toward the rear wall 24. The extension portion 34 may be formed integrally with the passing portion 33 or may be additionally attached to the passing portion 33.

The cassette 12 may include a lock member 35. The lock member 35 is configured to lock the hopper plate 28. The lock member 35 is configured to lock the hopper plate 28 at a lowered position. The lowered position is a position where the hopper plate 28 does not lift the media 99. The lowered position is a position where the hopper plate 28 is along the bottom wall 22. The lowered position is, for example, a lower limit position of the hopper plate 28. The lock member 35 locks the hopper plate 28 by the hopper plate 28 being displaced to the lowered position. The lock member 35 locks the hopper plate 28 by pressing the hopper plate 28. For example, the lock member 35 locks the hopper plate 28 by pressing the tip portion 31. The lock member 35 is attached to the container 21. The lock member 35 is attached to the bottom wall 22, for example.

### Main Body Portion

Then, the main body portion 13 will be described.

The main body portion 13 includes a housing 41. The housing 41 has a rectangular parallelepiped shape or is shaped like a rectangular parallelepiped. The housing 41 has a plurality of surfaces. The housing 41 has a front surface 42. In the housing 41, the front surface 42 is a surface facing forward. The front surface 42 is a surface facing a user who operates the recording apparatus 11. The housing 41 has a back surface 43. In the housing 41, the back surface 43 is a surface facing rearward. The back surface 43 is a surface opposite to the front surface 42. The housing 41 has an upper surface, a lower surface, side surfaces, and so on in addition to the front surface 42, the back surface 43, and so on.

The housing 41 houses various components provided to the recording apparatus 11. The housing 41 houses the recording unit 14. The housing 41 houses the conveyance unit 15. The housing 41 houses the liquid container 19.

The housing 41 is configured such that the cassette 12 is attached therein. When the cassette 12 is attached in the housing 41, the housing 41 houses the cassette 12. In one example, the cassette 12 is attached in the housing 41 by inserting the cassette 12 from the front surface 42 toward the back surface 43. The housing 41 is configured such that the front surface 42 is flush with a surface of the front wall 23 when the cassette 12 is attached.

A display opening 44 opens on the housing 41. The display opening 44 opens on the front surface 42. The display opening 44 is an opening that shows the remaining amount of the liquid in the liquid container 19. The display opening 44 exposes the liquid container 19. The display opening 44 exposes a portion formed of a light transmissive member out of the liquid container 19. Therefore, the user can check the remaining amount of the liquid in the liquid container 19 through the display opening 44.

An exposure opening 45 opens on the housing 41. Similarly to the display opening 44, the exposure opening 45 is an opening that exposes the inside of the housing 41. The exposure opening 45 opens on the front surface 42. In one example, the exposure opening 45 opens to be located between the display opening 44 and the cassette 12 when the housing 41 is viewed from the front. The exposure opening 45 is an opening showing the remaining amount of the media in the cassette 12.

The main body portion 13 includes a main body frame 46. The main body frame 46 is housed in the housing 41. The main body frame 46 is, for example, a sheet metal. The main body frame 46 includes a support plate 47. In the main body frame 46, the support plate 47 is a portion extending along the container 21. The support plate 47 extends along the container 21. The support plate 47 extends along the passage side wall 25. The support plate 47 extends from the front surface 42 toward the back surface 43. A through opening 48 opens on the support plate 47. The main body frame 46 includes a support shaft 49. The support shaft 49 extends from the support plate 47. The support shaft 49 extends from an opposite surface of the support plate 47 to a surface facing the passage side wall 25. The support shaft 49 extends along an axis L1.

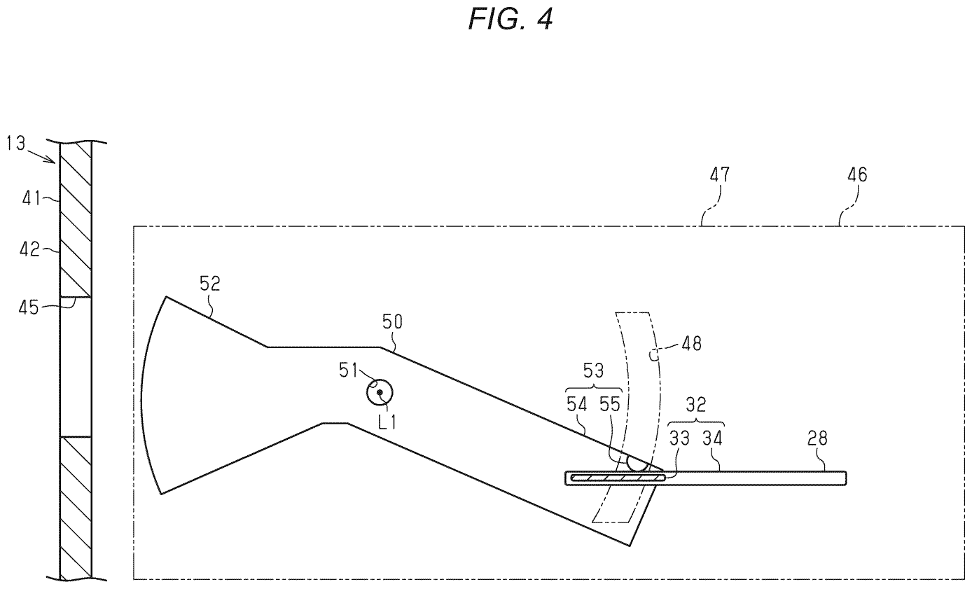

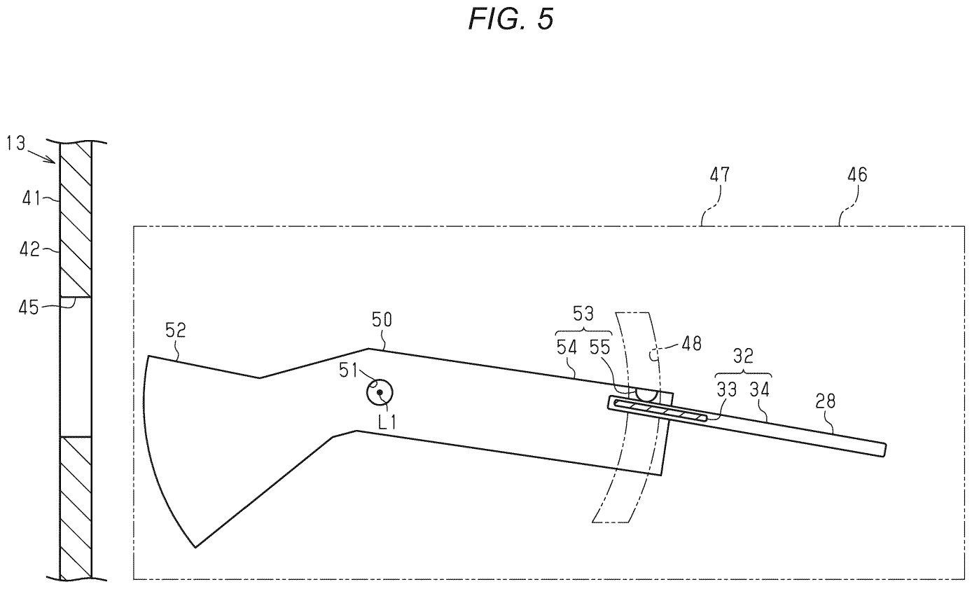

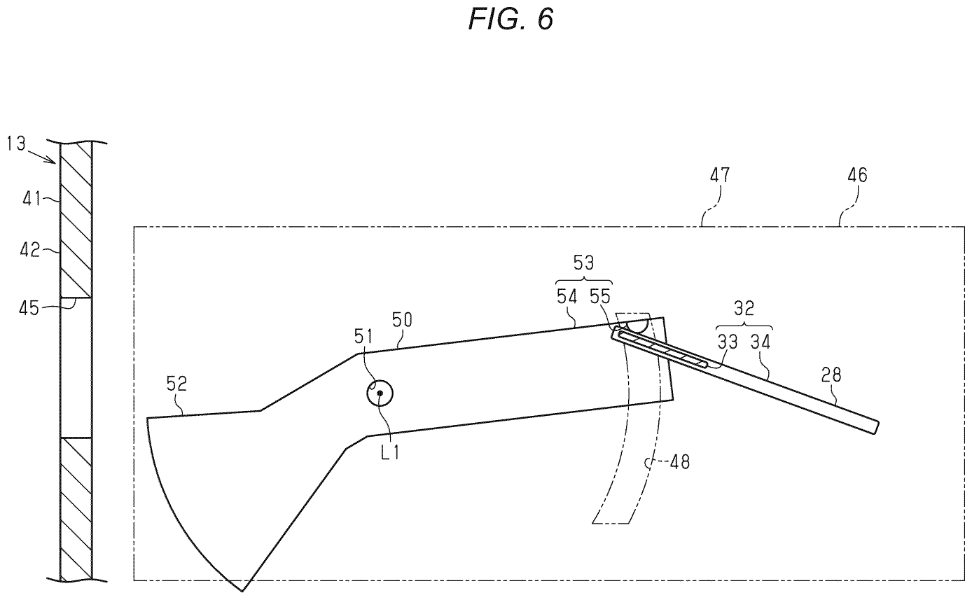

As illustrated in FIGS. 4, 5, and 6, the main body portion 13 includes a lever 50. The lever 50 is housed in the housing 41. The lever 50 is attached to the main body frame 46. The lever 50 is attached so as to be displaced with respect to the main body frame 46. Specifically, the lever 50 is attached so as to rotate with respect to the main body frame 46. The lever 50 is attached to the main body frame 46 so as to rotate about the axis L1. That is, the axis L1 is the rotation center of the lever 50. A shaft hole 51 centered on the axis L1 opens on the lever 50. The lever 50 is attached to the main body frame 46 by the support shaft 49 being inserted into the shaft hole 51. The lever 50 may have a shaft member extending along the axis L1 instead of the shaft hole 51.

The lever 50 is configured to move in conjunction with the hopper plate 28. The lever 50 is configured to be displaced as the hopper plate 28 moves up and down. In one example, the lever 50 is configured to rotate as the hopper plate 28 moves up and down.

The lever 50 is located so as to be exposed from the exposure opening 45. The lever 50 is located such that the area of a portion thereof exposed from the exposure opening 45 changes with the displacement. In one example, the lever 50 is located such that the exposed area changes as the lever 50 rotates.

The lever 50 is displaced so that the exposed area changes in accordance with the downward movement and the upward movement of the hopper plate 28. In one example, the lever 50 rotates such that the exposed area decreases as the hopper plate 28 moves up. When the hopper plate 28 moves down, the lever 50 rotates such that the exposed area increases.

In conjunction with the hopper plate 28, the lever 50 indicates the remaining amount of the media in the cassette 12. The lever 50 indicates the remaining amount of the media in the cassette 12 with the exposed area. The remaining amount of the media in the cassette 12 corresponds to a position of the hopper plate 28. When the remaining amount of the media in the cassette 12 is large, the hopper plate 28 is located at a lower position. When the remaining amount of the media in the cassette 12 is small, the hopper plate 28 is located at an upper position. Therefore, the exposed area of the lever 50 changes in accordance with the remaining amount of the media in the cassette 12. In one example, when the remaining amount of the media in the cassette 12 is large, the hopper plate 28 is located at a lower position to thereby increase the exposed area of the lever 50. When the remaining amount of the media in the cassette 12 is small, the hopper plate 28 is located at an upper position to thereby decrease the exposed area of the lever 50. The user can figure out the remaining amount of the media in the cassette 12 by visually recognizing the exposed area of the lever 50. Further, when the main body portion 13 includes the lever 50 as in an example, the cassette 12 can be reduced in size compared to when the cassette 12 includes the lever 50.

The lever 50 has an exposed portion 52. The exposed portion 52 is a portion exposed from the exposure opening 45 in the lever 50. The exposed portion 52 extends from the axis L1 of the lever 50 toward the front surface 42. The lever 50 displays the remaining amount of the media in the cassette 12 with the exposed area of the exposed portion 52. In one example, by the hopper plate 28 moving down, the lever 50 rotates such that the exposed portion 52 moves up. That is, the exposed portion 52 is exposed in the exposure opening 45 such that the amount of protrusion from a lower side toward an upper side increases as the remaining amount of the media in the cassette 12 increases. Accordingly, it is easy for the user to intuitively figure out the remaining amount of the media in the cassette 12.

The lever 50 has an acting portion 53. The acting portion 53 is a portion that receives force from the hopper plate 28. In one example, the acting portion 53 is supported by the hopper plate 28. The acting portion 53 extends from the exposed portion 52. The acting portion 53 extends from the axis L1 toward the back surface 43 in the lever 50.

The acting portion 53 is displaced together with the hopper plate 28. The acting portion 53 moves down as the hopper plate 28 moves down. The acting portion 53 moves up as the hopper plate 28 moves up. When the acting portion 53 is displaced, the exposed portion 52 is displaced. In one example, when the acting portion 53 moves down, the exposed portion 52 moves up. When the acting portion 53 moves up, the exposed portion 52 moves down. This changes the exposed area of the exposed portion 52. The lever 50 may be configured such that the moving direction of the exposed portion 52 coincides with the moving direction of the acting portion 53. For example, the lever 50 may be configured such that the exposed portion 52 moves down when the acting portion 53 moves down.

The weight of the acting portion 53 may be heavier than the weight of the exposed portion 52. In this case, the lever 50 is displaced not only by receiving force from the hopper plate 28 but also by its own weight. That is, when the hopper plate 28 moves down, the lever 50 is displaced by its own weight so that the acting portion 53 moves down and the exposed portion 52 moves up.

The acting portion 53 includes a base portion 54. The base portion 54 is a portion constituting a base of the acting portion 53. The base portion 54 is a portion extending along the main body frame 46 out of the acting portion 53. Specifically, the base portion 54 extends along the support plate 47.

The acting portion 53 has a contact portion 55. The contact portion 55 is a portion extending from the base portion 54. The contact portion 55 extends from the base portion 54 so as to approach the cassette 12. For example, the contact portion 55 extends perpendicularly to the support plate 47. In one example, the contact portion 55 extends to pass through the through opening 48. In the lever 50, the axis L1 is located between the contact portion 55 and the exposed portion 52 when viewed from a direction in which the axis L1 extends. Therefore, it is easy for the lever 50 to easily be displaced together with the hopper plate 28.

The contact portion 55 comes into contact with the hopper plate 28. Specifically, the contact portion 55 comes into contact with the protruding portion 32. In one example, the contact portion 55 comes into contact with the protruding portion 32 from above. The contact portion 55 is supported by the protruding portion 32. It can be said that the contact portion 55 engages with the hopper plate 28. Thus, the lever 50 moves in conjunction with the hopper plate 28. As the contact portion 55 is displaced, the exposed portion 52 is displaced. The contact portion 55 may be configured to be coupled to the protruding portion 32.

As shown in FIG. 3, the contact portion 55 is in contact with the protruding portion 32 between the main body frame 46 and the container 21. Specifically, the contact portion 55 is in contact with the protruding portion 32 between the main body frame 46 and the passage side wall 25. Thus, the contact portion 55 and the protruding portion 32 are protected by the main body frame 46 and the passage side wall 25. Therefore, the contact between the contact portion 55 and the protruding portion 32 is easily maintained.

When the hopper plate 28 moves up, the contact portion 55 is lifted by the protruding portion 32. In this case, the exposed area of the exposed portion 52 is reduced. When the hopper plate 28 moves down, the contact portion 55 moves down due to the own weight of the lever 50. This increases the exposed area of the exposed portion 52. In this way, the lever 50 displays the remaining amount of the media in the cassette 12.

The main body portion 13 may include a guide frame 56. The guide frame 56 is configured to guide the hopper plate 28. The guide frame 56 is configured to guide the hopper plate 28 in accordance with attachment and detachment of the cassette 12 with respect to the housing 41. Specifically, the guide frame 56 is configured to guide the hopper plate 28 so that the hopper plate 28 moves up and down in accordance with the cassette 12 being attached to and detached from the housing 41. The guide frame 56 may have a configuration integrated with the main body frame 46 or may have a configuration independent of the main body frame 46.

The guide frame 56 guides the hopper plate 28 by making contact with the hopper plate 28. The guide frame 56 guides the hopper plate 28 by making contact with the protruding portion 32. The guide frame 56 may be in contact with the passing portion 33 or the extension portion 34.

The guide frame 56 is housed in the housing 41. The guide frame 56 is located adjacent to the cassette 12. Specifically, the guide frame 56 is located so as to be adjacent to the passage side wall 25. The guide frame 56 is located between the main body frame 46 and the cassette 12. The guide frame 56 extends along the passage side wall 25.

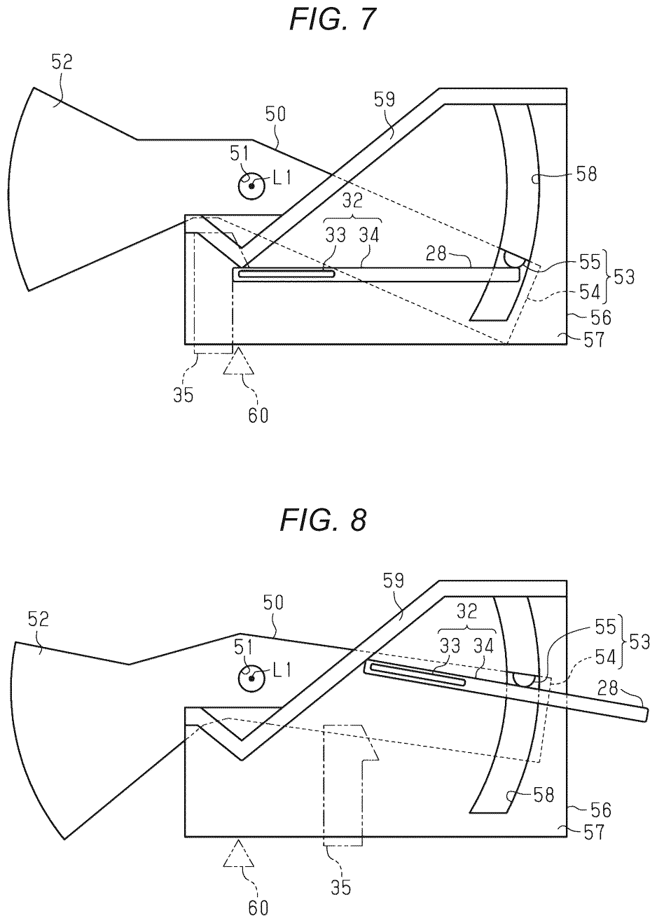

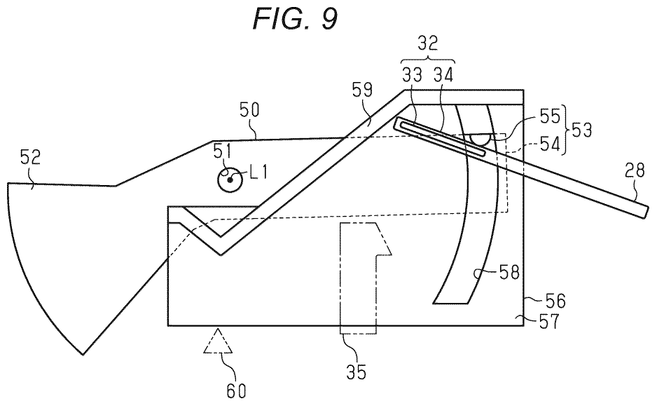

As illustrated in FIGS. 7, 8, and 9, the guide frame 56 includes a guide plate 57. The guide plate 57 is a plate extending along the container 21. Specifically, the guide plate 57 extends along the passage side wall 25. A guide opening 58 opens on the guide plate 57. The guide opening 58 extends vertically. The guide opening 58 extends in, for example, a circular arc shape. The guide opening 58 overlaps the through opening 48 when viewed in the direction in which the axis L1 extends.

The guide frame 56 includes a guide rail 59. The guide rail 59 is a rail that guides the hopper plate 28. The guide rail 59 extends from the guide plate 57. The guide rail 59 is located so as to protrude from a surface facing the passage side wall 25 out of the guide plate 57. The guide rail 59 is located so as to protrude from an upper edge of the guide plate 57. The guide rail 59 is located so as to come into contact with the hopper plate 28 from above. The guide rail 59 makes contact with the hopper plate 28 so as to press the hopper plate 28.

The guide rail 59 guides the hopper plate 28 in accordance with the cassette 12 being attached to or detached from the housing 41. The guide rail 59 guides the hopper plate 28 so as to move up and down in accordance with the cassette 12 being attached to and detached from the housing 41. Specifically, the guide rail 59 guides the hopper plate 28 so as to move down in accordance with the cassette 12 being detached from the housing 41. The guide rail 59 guides the hopper plate 28 so as to move up in accordance with the cassette 12 being attached in the housing 41.

The guide rail 59 extends so that a point on the guide rail 59 moves upward as it moves in a direction from the front to the rear of the recording apparatus 11. The guide rail 59 inclines so that a point on the guide rail 59 moves upward as it moves in the direction from the front to the rear of the recording apparatus 11. Accordingly, when the cassette 12 is pulled out from the housing 41, the hopper plate 28 moves down along the guide rail 59. When the cassette 12 is inserted into the housing 41, the hopper plate 28 moves up along the guide rail 59. In this way, since the hopper plate 28 automatically moves up and down as the cassette 12 is attached and detached, usability is improved. The hopper plate 28 is not limited to being guided by the guide frame 56, and may move up and down with, for example, electrical control.

When the cassette 12 is detached from the housing 41, the guide rail 59 guides the hopper plate 28 to the lowered position. Thus, the hopper plate 28 is locked by the lock member 35. Therefore, the cassette 12 is pulled out from the housing 41 in a state in which the hopper plate 28 is locked by the lock member 35. Therefore, it is easy for the user to replenish the cassette 12 with the media 99.

The main body portion 13 may include a release member 60. The release member 60 is a member that releases the lock by the lock member 35. The release member 60 is attached to, for example, the housing 41. The release member 60 releases the lock by the lock member 35 when the cassette 12 is attached in the housing 41. The release member 60 releases the lock by the lock member 35 by coming into contact with the lock member 35. The main body portion 13 releases the lock by the lock member 35 not only by the release member 60, but also by electrically controlling the lock member 35.

When the cassette 12 is inserted into the housing 41, the release member 60 is located so as to release the lock by the lock member 35 after the hopper plate 28 becomes able to make contact with the contact portion 55. In other words, the protruding portion 32 is configured to come into contact with the contact portion 55 before the lock by the lock member 35 is released by the release member 60. Specifically, the extension portion 34 extends so as to come into contact with the contact portion 55 before the lock by the lock member 35 is released by the release member 60. In one example, the extension portion 34 extends to reach an area below the contact portion 55 before the lock by the lock member 35 is released by the release member 60. Accordingly, when the cassette 12 is attached in the housing 41, the extension portion 34 is easily engaged with the contact portion 55. When the release member 60 supposedly releases the lock by the lock member 35 before the extension portion 34 reaches the area below the contact portion 55, there is a possibility that the extension portion 34 fails to engage with the contact portion 55.

### Functions and Advantages of Embodiment

Then, functions and advantages of the embodiment described above will be described.
(1) The lever 50 includes the contact portion 55 that comes into contact with the hopper plate 28 and the exposed portion 52 that is displaced as the contact portion 55 is displaced. The exposure opening 45 that exposes the exposed portion 52 opens on the housing 41. In the cassette 12, the degree of elevation of the hopper plate 28 changes with the remaining amount of the media 99 housed in the container 21. Therefore, the lever 50 is displaced in accordance with the remaining amount of the media 99 housed in the container 21. When the lever 50 is displaced, the exposed area of the exposed portion 52 exposed from the exposure opening 45 changes. That is, the exposed area of the exposed portion 52 exposed from the exposure opening 45 changes in accordance with the remaining amount of the media 99 housed in the container 21. Therefore, according to the configuration described above, the user can figure out the remaining amount of the media in the cassette 12 by checking the exposed portion 52 exposed from the exposure opening 45.
(2) The hopper plate 28 has a protruding portion 32 that protrudes outside the container 21. The container 21 has the passage side wall 25 wherein the passage opening 27 through which the protruding portion 32 passes opens on the passage side wall 25. The contact portion 55 is in contact with the protruding portion 32. According to the configuration described above, the lever 50 can move in conjunction with the hopper plate 28 with a simple configuration.
(3) The contact portion 55 is in contact with the protruding portion 32 between the main body frame 46 and the passage side wall 25. According to the configuration described above, the contact portion 55 and the protruding portion 32 are protected by the main body frame 46 and the passage side wall 25. Accordingly, the contact between the contact portion 55 and the protruding portion 32 is easily maintained.
(4) The rotation center of the lever 50 is located between the contact portion 55 and the exposed portion 52. According to the configuration described above, it becomes easy for the lever 50 to be displaced together with the hopper plate 28.
(5) The guide frame 56 includes a guide rail 59 that guides the hopper plate 28 so as to move down in accordance with the cassette 12 being detached from the housing 41 and to move up in accordance with the cassette 12 being attached in the housing 41. According to the configuration described above, since the hopper plate 28 automatically moves up and down as the cassette 12 is attached and detached, usability is improved.
(6) The extension portion 34 extends so as to come into contact with the contact portion 55 before the lock by the lock member 35 is released by the release member 60. When the cassette 12 is detached from the housing 41, the contact portion 55 is separated from the protruding portion 32. Therefore, when the cassette 12 is attached to the housing 41, when the lock by the lock member 35 is released before the contact portion 55 comes into contact with the protruding portion 32, there is a possibility that the lever 50 cannot move in conjunction with the hopper plate 28. According to the configuration described above, since the lock by the lock member 35 is released after the contact portion 55 comes into contact with the protruding portion 32, the lever 50 can move in conjunction with the hopper plate 28.
(7) The cassette 12 is attached in the housing 41 by being inserted into the housing 41 from the front surface 42 toward the back surface 43. According to the configuration described above, it is easy for the user to easily attach and detach the cassette 12 to and from the housing 41.
(8) The exposure opening 45 is located between the display opening 44 and the cassette 12 when the housing 41 is viewed from the front. According to the configuration described above, the exposure opening 45 is located in the vicinity of the display opening 44. Therefore, it becomes easy for the user to check the exposure opening 45 and the display opening 44 at once. This improves the usability.

### Technical Ideas

Technical ideas figured out from the embodiment and the modified examples described above, and the functions and advantages thereof will hereinafter be described.
(A) A recording apparatus includes a cassette configured to house a medium, a main body portion in which the cassette is attached, and a recording unit configured to record an image on the medium, wherein the cassette includes a container configured to house the media, and a hopper plate attached to the container, the main body portion includes a housing in which the cassette is attached, and a lever that is housed in the housing and is configured to move in conjunction with the hopper plate, the lever includes a contact portion configured to come into contact with the hopper plate, and an exposed portion configured to be displaced as the contact portion is displaced, and an exposure opening configured to expose the exposed portion opens on the housing. In the cassette, the degree of elevation of the hopper plate changes with the remaining amount of the media housed in the container. Therefore, the lever is displaced in accordance with the remaining amount of the media housed in the container. When the lever is displaced, the area of the exposed portion exposed from the exposure opening changes. That is, the exposed area of the exposed portion exposed from the exposure opening changes in accordance with the remaining amount of the media housed in the container. Therefore, according to the configuration described above, the user can figure out the remaining amount of the media in the cassette by checking the exposed portion exposed from the exposure opening.
(B) In the recording apparatus described above, the main body portion may include a main body frame housed in the housing, the lever may be attached to the main body frame, the hopper plate may include a protruding portion protruding outside the container, the container may include a passage side wall on which a passage opening through which the protruding portion passes opens, and the contact portion may come into contact with the protruding portion. According to the configuration described above, the lever can move in conjunction with the hopper plate with a simple configuration.
(C) In the recording apparatus described above, the contact portion may be in contact with the protruding portion between the main body frame and the passage side wall. According to the configuration described above, the contact portion and the protruding portion are protected by the main body frame and the passage side wall. Accordingly, the contact between the contact portion and the protruding portion is easily maintained.
(D) In the recording apparatus described above, the lever may be configured to rotate with respect to the main body frame, and a rotation center of the lever may be located between the contact portion and the exposed portion. According to the configuration described above, it becomes easy for the lever to be displaced together with the hopper plate.
(E) In the recording apparatus described above, the main body portion may include a guide frame configured to guide the hopper plate in accordance with the cassette being attached to or detached from the housing, and the guide frame may include a guide rail configured to guide the hopper plate so as to move down in accordance with the cassette being detached from the housing and to move up in accordance with the cassette being attached in the housing. According to the configuration described above, since the hopper plate automatically moves up and down as the cassette is attached and detached, usability is improved.
(F) In the recording apparatus described above, the cassette may include a lock member configured to lock the hopper plate at a lowered position when the cassette is detached from the housing, the main body portion may include a release member configured to release the lock by the lock member when the cassette is attached in the housing, the protruding portion may include a passing portion configured to extend so as to pass through the passage opening, and an extension portion configured to extend from the passing portion along the passage side wall, and the extension portion may extend so as to come into contact with the contact portion before the lock by the lock member is released by the release member. When the cassette is detached from the housing, the contact portion is separated from the protruding portion. Therefore, when the cassette is attached to the housing, when the lock by the lock member is released before the contact portion comes into contact with the protruding portion, there is a possibility that the lever cannot move in conjunction with the hopper plate. According to the configuration described above, since the lock by the lock member is released after the contact portion comes into contact with the protruding portion, the lever can move in conjunction with the hopper plate.
(G) The recording apparatus may further include a supply roller configured to come into contact with the medium housed in the cassette, wherein the supply roller may convey the media from a back surface of the housing toward a front surface of the housing, and the cassette may be attached in the housing by being inserted into the housing from the front surface toward the back surface. According to the configuration described above, it is easy for the user to easily attach and detach the cassette to and from the housing.
(H) The recording apparatus may further include a liquid container configured to store a liquid to be supplied to the recording unit, wherein a display opening configured to show a remaining amount of the liquid by exposing the liquid container may open on the housing, and the exposure opening may be located between the display opening and the cassette when the housing is viewed from the front. According to the configuration described above, the exposure opening is located in the vicinity of the display opening. Therefore, it becomes easy for the user to check the exposure opening and the display opening at once. This improves the usability.

What is claimed is:

1. A recording apparatus comprising:
a cassette configured to house a medium;
a main body portion in which the cassette is attached; and
a recording unit configured to record an image on the medium, wherein
the cassette includes
a container configured to house the media, and
a hopper plate attached to the container,
the main body portion includes
a housing in which the cassette is attached, and
a lever that is housed in the housing and is configured to move in conjunction with the hopper plate,
the lever includes
a contact portion configured to come into contact with the hopper plate, and
an exposed portion configured to be displaced as the contact portion is displaced, and
an exposure opening configured to expose the exposed portion opens on the housing.

2. The recording apparatus according to claim 1, wherein
the main body portion includes a main body frame housed in the housing,
the lever is attached to the main body frame,
the hopper plate includes a protruding portion protruding outside the container,
the container includes a passage side wall on which a passage opening through which the protruding portion passes opens, and
the contact portion comes into contact with the protruding portion.

3. The recording apparatus according to claim 2, wherein
the contact portion is in contact with the protruding portion between the main body frame and the passage side wall.

4. The recording apparatus according to claim 2, wherein
the lever is configured to rotate with respect to the main body frame, and
a rotation center of the lever is located between the contact portion and the exposed portion.

5. The recording apparatus according to claim 2, wherein
the main body portion includes a guide frame configured to guide the hopper plate in accordance with the cassette being attached to or detached from the housing, and
the guide frame includes a guide rail configured to guide the hopper plate so as to move down in accordance with the cassette being detached from the housing and to move up in accordance with the cassette being attached in the housing.

6. The recording apparatus according to claim 5, wherein
the cassette includes a lock member configured to lock the hopper plate at a lowered position when the cassette is detached from the housing,
the main body portion includes a release member configured to release the lock by the lock member when the cassette is attached in the housing,
the protruding portion includes
a passing portion configured to extend so as to pass through the passage opening, and
an extension portion configured to extend from the passing portion along the passage side wall, and
the extension portion extends so as to come into contact with the contact portion before the lock by the lock member is released by the release member.

7. The recording apparatus according to claim 1, further comprising
a supply roller configured to come into contact with the medium housed in the cassette, wherein
the supply roller conveys the media from a back surface of the housing toward a front surface of the housing, and
the cassette is attached in the housing by being inserted into the housing from the front surface toward the back surface.

8. The recording apparatus according to claim 1, further comprising
a liquid container configured to store a liquid to be supplied to the recording unit, wherein
a display opening configured to show a remaining amount of the liquid by exposing the liquid container opens on the housing, and
the exposure opening is located between the display opening and the cassette when the housing is viewed from the front.
